(19) United States
(12) Patent Application Publication
(10) Pub. No.: US 2005/0168624 A1
(43) Pub. Date: Aug. 4, 2005

(54) Image capturing apparatus

(75) Inventor: Yasushi Hasegawa, Sakai-shi (JP)

Correspondence Address: SIDLEY AUSTIN BROWN & WOOD LLP, 717 NORTH HARWOOD, SUITE 3400, DALLAS, TX, 75201, US

(73) Assignee: KONICA MINOLTA PHOTO IMAGING, INC.

(21) Appl. No.: 11/043,773

(22) Filed: Jan. 26, 2005

(30) Foreign Application Priority Data
Feb. 4, 2004 (JP) 2004-028213

(51) Int. Cl. H04N 5/235

(52) U.S. Cl. 348/362

(57) ABSTRACT

An image capturing apparatus having a light emission section for emitting flash and to which a close-up lens is mounted. The image capturing apparatus further includes a detecting section which detects that the close-up lens is mounted to the image capturing apparatus, and a controller which switches a flash shooting control of the light emission section from a dimmer control to a flashmatic control when the detecting section detects that the close-up lens is mounted to the image capturing apparatus.

This application is based on Japanese Patent Application No. 2004-28213 filed in Japan on Feb. 4, 2004, the entire content of which is hereby incorporated by reference.

### BACKGROUND OF THE INVENTION

1. Field of the Invention

The present invention relates to an image capturing apparatus such as a camera, and more particularly, a control technique for flash shooting with a camera.

2. Description of the Related Art

A conventional image capturing apparatus such as a camera uses automatic dimmer control or flashmatic control as a flash shooting control method. During automatic dimmer control, a light receiving element directly coupled with a flash circuit detects flash reflected by a subject and firing of flash is stopped when appropriate exposure is achieved. Meanwhile, during flashmatic control, the firing amount of flash or an aperture diaphragm is automatically changed in accordance with a distance to the subject during flash shooting.

However, a camera for flash shooting utilizing automatic dimmer control has a problem that adjustment of light is difficult and overexposure tends to occur in the case of short-distance shooting at a distance of about scores of centimeters from a subject.

Meanwhile, various methods are available as methods of measuring a distance from a subject for flashmatic control, one of which is a method of calculating a subject distance in accordance with the focusing state of a image taking lens. For instance, an image capturing apparatus performs autofocus control, and a distance to a subject can be calculated from the location of the lens as it is with the image of the subject brought into focus. However, the subject distance calculated in accordance with the focusing state of the image taking lens is calculated at a resolution which is yielded by dividing a distance between infinite distance and the closest location by a finite number, resulting in a problem that it is not possible to accurately calculate a distance to a subject which is at a short distance and that it is not possible to optimally shoot the subject even with flashmatic control photography. If the distance to the subject is to be calculated at a high accuracy, there arises another problem that a lens drive system becomes complex and costs increase.

### SUMMARY OF THE INVENTION

A principal object of the present invention is to provide an image capturing apparatus which suppresses overexposure and obtains an optimal image even during flash shooting of a subject which is at a short distance.

The object above of the present invention is achieved by an image capturing apparatus comprises: a light emission section which emits flash; a first optical system which directs a light image of a subject to an imaging element; an aperture diaphragm member which adjusts a light amount directed by said first optical system; a distance detecting section which detects a distance information to the subject based upon a focusing state of the light image of the subject obtained through the first optical system; a second optical system mounted to an objective side of the first optical system; a detecting section which detects that the second optical system is mounted to the first optical system; a storage section which stores an information regarding the second optical system; and a controller, when the detecting section detects that the second optical system is mounted to the first optical system, said controller correcting said distance information detected by said distance detecting section based upon the information regarding the second optical system, and performing flash shooting while adjusting at least one of the amount of light emitted by the light emission section, the aperture diaphragm value of the aperture diaphragm member and a gain applied upon an image signal obtained by the imaging element based on corrected distance information.

The object above of the present invention is achieved by an image capturing apparatus, which is provided with a light emission section for emitting flash and to which a close-up lens is mounted, said image capturing apparatus comprising: a detecting section which detects that the close-up lens is mounted to the image capturing apparatus; and a controller which switches a flash shooting control of said light emission section from a dimmer control to a flashmatic control when the detecting section detects that the close-up lens is mounted to the image capturing apparatus.

These and other objects, advantages and features of the invention will become apparent from the following description thereof taken in conjunction with the accompanying drawings, which illustrate specific embodiments of the invention.

### BRIEF DESCRIPTION OF DRAWINGS

These and other objects, advantages and features of the invention will become apparent from the following description thereof taken in conjunction with the accompanying drawings in which:

FIG. 1 is a perspective drawing which schematically shows an image capturing apparatus;

FIG. 2 is a perspective drawing which schematically shows the image capturing apparatus as it is with the respective portions mounted to a main camera section;

FIG. 3 is a block diagram of an internal structure of the image capturing apparatus;

FIG. 4 is a drawing which shows a distance to a subject which is specified by the lens location of a focusing lens;

FIG. 5 is a drawing which shows a relationship between a distance to a subject and a DV error;

FIG. 6 is a flow chart which shows operation procedures of the image capturing apparatus; and

FIG. 7 is a flow chart which shows operation procedures of the image capturing apparatus.

### DESCRIPTION OF THE PREFERRED EMBODIMENTS

A preferred embodiment of the present invention will now be described in detail with reference to drawings.

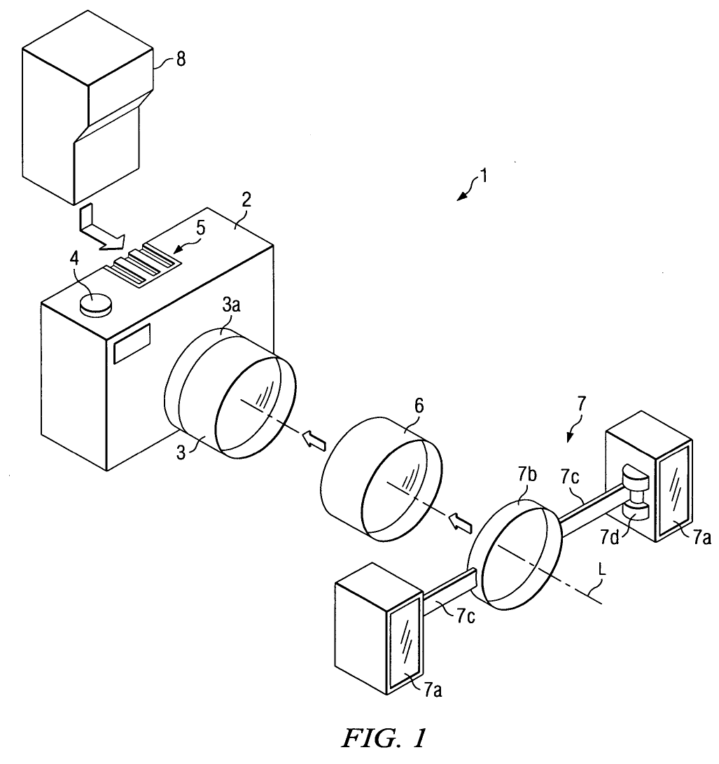

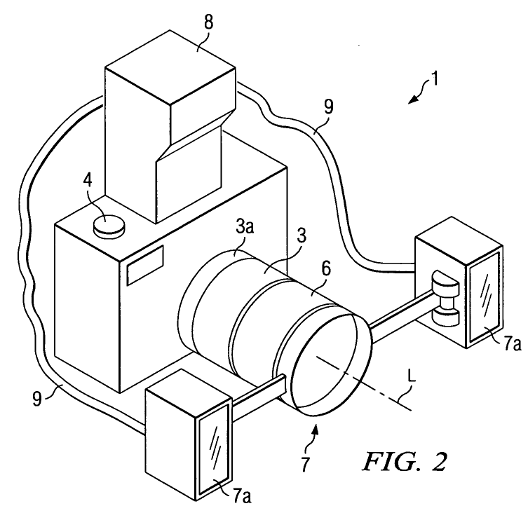

FIGS. 1 and 2 are perspective drawings which show a schematic structure of an image capturing apparatus 1 according to this preferred embodiment. As shown in FIG. 1, an image taking lens 3 is disposed to a front surface of a main camera body 2 of the image capturing apparatus 1, while a shutter button 4 and a flash connection section 5 which is for connecting an external flash are disposed to a top surface of the main camera body 2.

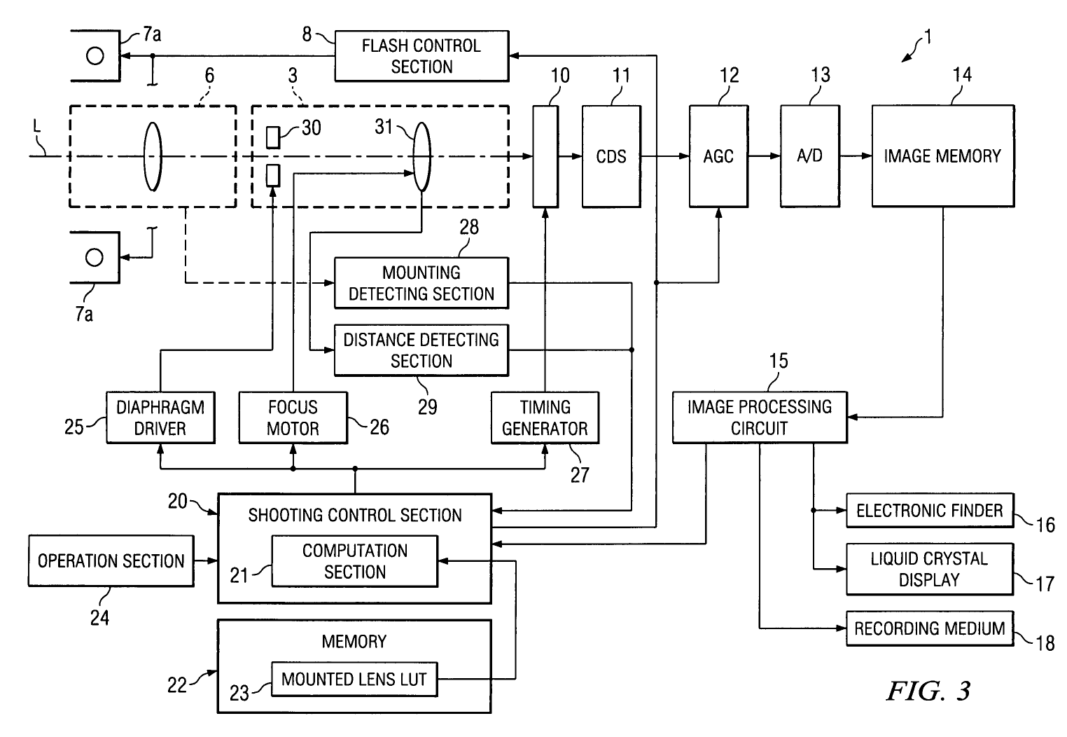

The image taking lens 3 is an optical system which is for shooting an ordinary subject, and the shooting range of the image taking lens 3 is from the closest location, which is at about scores of centimeters on the forward side from the image taking lens 3, to infinite distance. A focusing lens 31 (FIG. 3) for focal adjustment and a diaphragm plate 30 (FIG. 3) are disposed inside the image taking lens 3 due to which as the focusing lens moves along an optical axis L, a subject which is at a freely chosen location between the closest location and infinite distance is favorably brought into focus. The image taking lens 3 comprises a focusing ring 3a, and when a user manually turns the focusing ring 3a, the focusing lens within the image taking lens 3 moves along the optical axis L, whereby the focusing state of the image of the subject is adjusted manually. Further, the image capturing apparatus 1 is equipped with an autofocus function, and therefore, when a user presses the shutter button 4 halfway for instance, autofocus control starts and the image of the subject is automatically brought into focus.

The shutter button 4 is a press switch which is capable of detecting and distinguishing two different stages of half-press and full-press. For example, autofocusing described above is executed when half-press is detected, whereas a shooting operation for recording an image is initiated when full-press is detected.

A front end portion (objective-side end portion) of the image taking lens 3 is structured such that other optical lens can be mounted, and in this preferred embodiment, a close-up lens 6 is mounted to the front end portion of the image taking lens 3. The close-up lens 6 is an optical lens for shooting over a short distance and serves as an optical system which translates the shooting range of the image capturing apparatus 1 into a short-distance region (macro region) which is over from about scores of centimeters to about a few meters. Hence, while the image capturing apparatus 1 favorably focuses on a subject which is in the short-distance region described above as the close-up lens 6 is mounted to the image taking lens 3, the image capturing apparatus 1 can not focus on a subject which is outside the short-distance region even though the focusing lens moves. In other words, with the close-up lens 6 mounted to the image taking lens 3, the structure of the optical system of the image capturing apparatus 1 is suitable to short-distance shooting. A front end portion of the close-up lens 6 has such a structure which accepts a flash apparatus 7 for short-distance shooting. The flash apparatus 7 is comprised of light emission parts 7a which fires flash, a ring member 7b which is fit to the front end portion of the close-up lens 6, and arms 7c which are connected with the ring member 7b and support the light emission section 7a. In the example shown in FIGS. 1 and 2, the plurality of light emission parts 7a are arranged symmetrical with respect to the optical axis L so that the light emission parts 7a are equidistant from the optical axis L. In addition, the light emission parts 7a and the arms 7c are linked through rotating members 7d, and the angles of the light emission parts 7a with respect to the optical axis L can be adjusted freely.

A flash control section 8 which controls firing from the flash apparatus 7 is mounted to the flash connection section 5 of the main camera body 2. A power source for supplying electric power for firing to the light emission parts 7a is, among other components, incorporated inside the flash control section 8. As shown in FIG. 2, with the flash control section 8 and the light emission parts 7a electrically connected via a cable 9, the flash control section 8 can control firing at the light emission parts 7a.

As shown in FIG. 2, the close-up lens 6 is mounted to the image taking lens 3, the flash apparatus 7 is mounted to the close-up lens 6 and the flash control section 8 is mounted to the main camera body 2, thereby making the image capturing apparatus 1 have a hardware structure which realizes short-distance shooting under flash illumination.

Available as control methods for an instance that the image capturing apparatus 1 performs flash shooting are dimmer control or flashmatic control. Dimmer control is used when the close-up lens 6 is not mounted to the image capturing apparatus 1, during which for example the light emission parts 7a fire preflash prior to shooting, reflected light is measured and the amount of light emission during shooting is determined. On the contrary, with the close-up lens 6 mounted to the image capturing apparatus 1, flashmatic control is used for flash shooting of a subject which is in the short-distance region and the amount of light emission is determined based on the distance to the subject.

FIG. 3 is a block diagram of an internal structure of the image capturing apparatus as it is with the close-up lens 6, the flash apparatus 7 and the flash control section 8 mounted to the main camera body 2. As described above, the image taking lens 3 comprises the diaphragm plate 30 whose aperture diameter can be adjusted and the focusing lens 31 which is for adjustment of the focusing state of the image of the subject which is formed on an imaging element 10. The imaging element 10 is photoelectric transfer means which is formed by a CCD image sensor, a CMOS sensor or the like and generates an electric image signal in response to receipt of light which impinges via the close-up lens 6 and the image taking lens 3.

A CDS circuit (correlative double sampling circuit) 11 performs predetermined signal processing of the image signal generated by the imaging element 10, an AGC circuit (automatic gain control circuit) 12 applies a gain to the image signal, and the level of the signal is accordingly adjusted. The gain applied by the AGC circuit 12 aims at adjustment of the sensitivity of the imaging element 10, and a shooting control section 20 sets the value of the gain. The image signal whose level is adjusted by the AGC circuit 12 is converted from an analog signal to a digital signal by an A/D converter 13 and then stored temporarily in an image memory 14.

An image processing circuit 15 is computation means which is structured so as to execute various image processing, and outputs the image signal generated as a result of the various image processing to an electronic finder 16, a liquid crystal display 17, a recording medium 18 or the shooting control section 20. The electronic finder 16, the liquid crystal display 17 and the like are disposed to a back surface of the image capturing apparatus 1 for a user to confirm an image, and in order to display thus shot image on these display means, image processing suitable to displaying by each display means is executed. Further, for recording of the image signal acquired through the shooting operation in the recording medium 18 such as a memory card, the image signal is compressed or otherwise processed and thereafter recorded in the recording medium 18. During autofocusing, a partial image which corresponds to a predetermined focus area is extracted from the image obtained by the imaging element 10 and output to the shooting control section 20.

The shooting control section 20 is formed by a microcomputer or the like and executes universal control of the shooting operation by the image capturing apparatus 1. When the close-up lens 6 is not mounted to the image capturing apparatus 1, the shooting control section 20 controls so as to optimally shoot a subject which is at a freely chosen location between the closest location and infinite distance. On the contrary, with the close-up lens 6 mounted to the image capturing apparatus 1, the shooting control section 20 controls so as to optimally shoot a subject which is in the short-distance region which is defined by the close-up lens 6. Particularly in the event that the close-up lens 6 and the flash control section 8 are mounted to the image capturing apparatus 1 and the image capturing apparatus 1 performs flash shooting at a short distance, the shooting control section 20 switches flash shooting to flashmatic control, thus making it possible to optimally shoot a subject which is at a short distance under flash illumination.

Further, during autofocusing, the shooting control section 20 moves the focusing lens 31 at a predetermined pitch, calculates the contrasts of partial images which are fed sequentially from the image processing circuit 15 and specifies a location where these contrasts become the highest as a focus position. Following this, as the focusing lens 31 moves to thus specified focus position, the image of the subject which is formed on the imaging element 10 is brought into focus.

A diaphragm driver 25 is for adjustment of the aperture diameter of the diaphragm plate 30 by driving the diaphragm plate 30 disposed to the image taking lens 3, and drives the diaphragm plate 30 based on a command received from the shooting control section 20.

A focus motor 26 is for moving the focusing lens 31 disposed to the image taking lens 30 along the optical axis L at a predetermined pitch during autofocusing, and drives the focusing lens 31 based on the direction and the amount of movement instructed by the shooting control section 20. As described above, the focusing lens 31 moves along the optical axis L also when a user manually operates the focusing ring 3a.

A timing generator 27 is for sending to the imaging element 10 timing signals which are indicative of the start and the end of exposure based on a command for shooting received from the shooting control section 20.

A mounting detecting section 28 is detecting means which detects mounting of other optical lens to the image taking lens 3, and as such, specifies the type of the lens and the like upon detection of mounting of the lens to the image taking lens 3. Information detected by the mounting detecting section 28 is transmitted to the shooting control section 20. Hence, when the close-up lens 6 is mounted to the image taking lens 3, the mounting detecting section 28 sends to the shooting control section 20 a signal indicative of mounting of the close-up lens 6. A distance detecting section 29 is for creating information on a distance to a subject based on how the focusing lens 31 focuses on the image of the subject. To be more specific, when the location of the focusing lens 31 is determined by means of autofocusing or manual focusing, based upon this lens lodation the distance detecting section 29 determines where the subject is within the shooting range of the image taking lens 3, and creates distance information. The distance detecting section 29 thus specifies where the subject is located within the shooting range (which is the range from the closest location to infinite distance) based on the optical characteristic of the image taking lens 3. The distance information detected by the distance detecting section 29 is output to the shooting control section 20.

An operation section 24 is an operation member which a user operates to make various entries in the image capturing apparatus 1, and comprises the shutter button 4 described above and also various operation buttons not shown which are disposed to the back surface of the image capturing apparatus 1, etc.

A memory 22 is memory means which stores control data which are used by the shooting control section 20, and stores for example a mounted lens LUT (look-up table) 23. The mounted lens LUT 23 is for storing, in the form of table data, information regarding other optical lens mounted to the image taking lens 3, and in this preferred embodiment, information regarding the close-up lens 6 is stored.

In such a structure, in the event that the mounting detecting section 28 has detected mounting of the close-up lens 6 and the flash control section 8 is mounted to the flash connection section 5, as a user sets so as to shoot under flash illumination, the shooting control section 20 executes flashmatic control when the shutter button 4 is fully pressed.

Flashmatic control in the case of the image capturing apparatus according to the preferred embodiment of the present invention will now be described. Flashmatic control is such control for carrying out flash shooting such that a subject as viewed from the imaging element 10 always stays at constant brightness, and where the symbol IV denotes the amount of light emission at the light emission parts 7a, the symbol AV denotes the aperture diaphragm value of the diaphragm plate 30, the symbol SV denotes the sensitivity at the AGC circuit and the symbol DV denotes a distance from the image capturing apparatus 1 to a subject (i.e., a subject distance), at least one of the amount of light emission IV, the aperture diaphragm value AV and the sensitivity SV is determined such that these values satisfy the following relationship:
IV=AV+DV−SV+5 (Equation 1)
and flash shooting is performed using these values under this control. Each one of the values IV, AV, SV and DV described above is a value expressed in terms of APEX (Additive System of Photographic Exposure).

For instance, in the event that the aperture diaphragm value AV and the sensitivity SV are determined in advance, the control ensures that the longer the subject distance DV from the image capturing apparatus 1 to a subject becomes (that is, the farther the subject is from the image capturing apparatus 1), the greater the firing amount of flash IV becomes, and conversely, the shorter the subject distance DV becomes, the smaller the amount of light emission IV becomes, whereby the amount of light emission at the light emission parts 7a is controlled such that the subject as viewed from the imaging element 10 always stays at constant brightness.

As the firing amount of flash from the light emission parts 7a is reduced gradually, at or below a certain lower limit value, accurate control of the amount of light emission becomes impossible. When this occurs, such control is exercised so that the aperture diaphragm value AV or the sensitivity SV is adjusted while the firing amount of flash is fixed to the lower limit value and the Equation 1 above is satisfied. For example, where a subject is at the closest location which permits the image capturing apparatus 1 shoot the subject and the subject distance DV is an extremely small value, the amount of light emission IV could become equal to or smaller than the lower limit value. Accordingly, the amount of light emission IV is fixed to the lower limit value and the aperture diaphragm value AV is updated to a greater value or the value of the sensitivity SV is updated to a smaller value in accordance with the Equation 1 described above. As a result, even under a circumstance which does not allow a reduction of the amount of light emission IV, the aperture diameter of the diaphragm plate 30 may be reduced thereby reducing light components which are guided to the imaging element 10 or the gain in the AGC circuit 12 may be reduced thereby lowering the signal level of the image signal.

With flashmatic control executed while the image capturing apparatus 1 mounting the close-up lens 6 performs short-distance flash shooting, firing of preflash at the light emission parts 7a is not needed and shooting is carried out such that the subject as viewed from the imaging element 10 always stays at constant brightness. This prevents thus shot image from getting overexposed or underexposed. Further, flashmatic control is control of flash which is not susceptible to the reflectance of a subject, and therefore, it is possible to faithfully reproduce the tone of the subject in thus shot image. Since color reproducibility is regarded important particularly in the case of short-distance shooting, this is control of flash which is suitable to short-distance shooting.

When flashmatic control as that described above is to be executed, in light of the Equation 1 described above, the subject distance DV needs to be calculated accurately. To this end, the preferred embodiment demands execution of flashmatic control using the distance information detected by the distance detecting section 29.

The distance detecting section 29 is nevertheless for calculation of distance information from the optical characteristic of the image taking lens 3 as it is alone as described above, and therefore, distance information yielded by the distance detecting section 29 can not be used directly for flashmatic control when the close-up lens 6 remains mounted. The reason is that the distance detecting section 29 is for calculation of distance information on the premise that the shooting range of the image capturing apparatus 1 is the range from the closest location to infinite distance, the shooting range is translated with the close-up lens 6 remaining mounted, and a region in which the subject can be brought into focus by moving the focusing lens 31 is limited to the short-distance region.

To solve the above-mentioned problem, the memory 22 in the preferred embodiment stores, as the mounted lens LUT 23, correction information which is for correcting the distance information detected by the distance detecting section 29 based on the optical characteristic of the close-up lens 6. Upon inputting of distance information X from the distance detecting section 29 to a computation section 21 of the shooting control section 20, the mounted lens LUT 23 is read from the memory 22 and the correction information is acquired, and through predetermined computation, distance information X′ corrected to be adapted to the optical characteristic as it is with the close-up lens 6 mounted is calculated.

The corrected distance information X′ is calculated by the calculation below:
X′=X·f/(X+f) (Equation 2)
on the assumption that the focal length f of the close-up lens 6 is stored as the correction information. The calculation expressed as Equation 2 may be done in advance and the relationship between pre-correction and post-correction distance information (i.e., between X and X′) may be stored as table data in the mounted lens LUT 23.

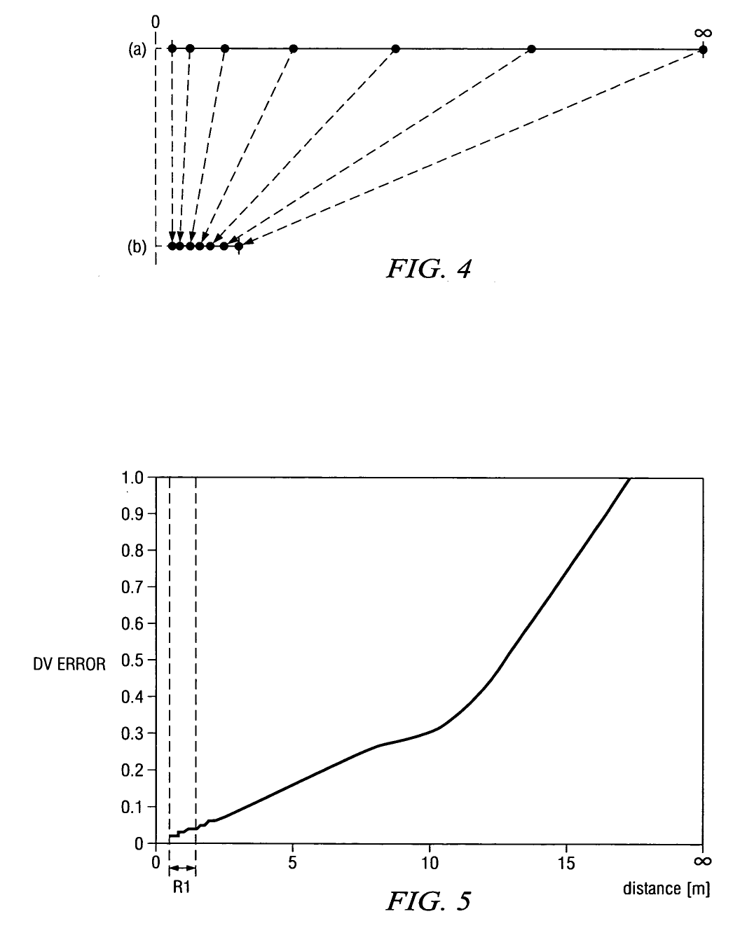

FIG. 4 is a drawing which shows a distance to a subject which is specified by the lens location of the focusing lens 31, wherein the region denoted at the solid line is the shooting range and each black point expresses a subject distance which corresponds to the location at which the focusing lens 31 stops.

In the event that the close-up lens 6 is not mounted to the image capturing apparatus 1 for example, as shown in the section (a) in FIG. 4, the lens location of the focusing lens 31 specifies where the subject is located within the range from the closest location to infinite distance. On the contrary, when the close-up lens 6 is mounted to the image capturing apparatus 1, as shown in the section (b) in FIG. 4, the shooting range is limited to the short-distance region.

Assuming that the focusing lens 31 stops at seven locations as shown in FIG. 4 for instance, with the close-up lens 6 mounted, each one of these seven lens locations denotes a subject distance within the short-distance region (See FIG. 4(b).).

Thus, as the close-up lens 6 is mounted, the shooting control section 20 corrects the distance information detected by the distance detecting section 29 based on the information regarding the close-up lens 6, whereby a subject distance within the short-distance region is calculated at a high resolution. From the distance information X′ corrected by the computation section 21 of the shooting control section 20, the subject distance DV in terms of APEX is calculated. The subject distance DV thus calculated is a highly accurate value which is less error-prone. FIG. 5 is a drawing which shows a relationship between a distance to a subject (m) and a DV error as it is when the subject distance DV in terms of APEX is calculated from the distance (m). When shooting using the close-up lens 6 with the shooting range limited to the short-distance region Rl as in the preferred embodiment, a DV error associated with calculation of the subject distance DV for flashmatic control is suppressed into an extremely narrow range. In this manner, the subject distance DV which is less error-prone is calculated at a high accuracy.

Once the subject distance DV is calculated, the sensitivity SV corresponding to the firing amount of flash IV from the light emission parts 7a, the aperture diaphragm value AV of the diaphragm plate 30 or the gain in the AGC circuit 12 is determined in accordance with Equation 1 described above, the shooting control section 20 sets up the flash control section 8, the diaphragm driver 25 and the AGC circuit 12 based on these respective values, and flash shooting is controlled in response to full-press of the shutter button 4.

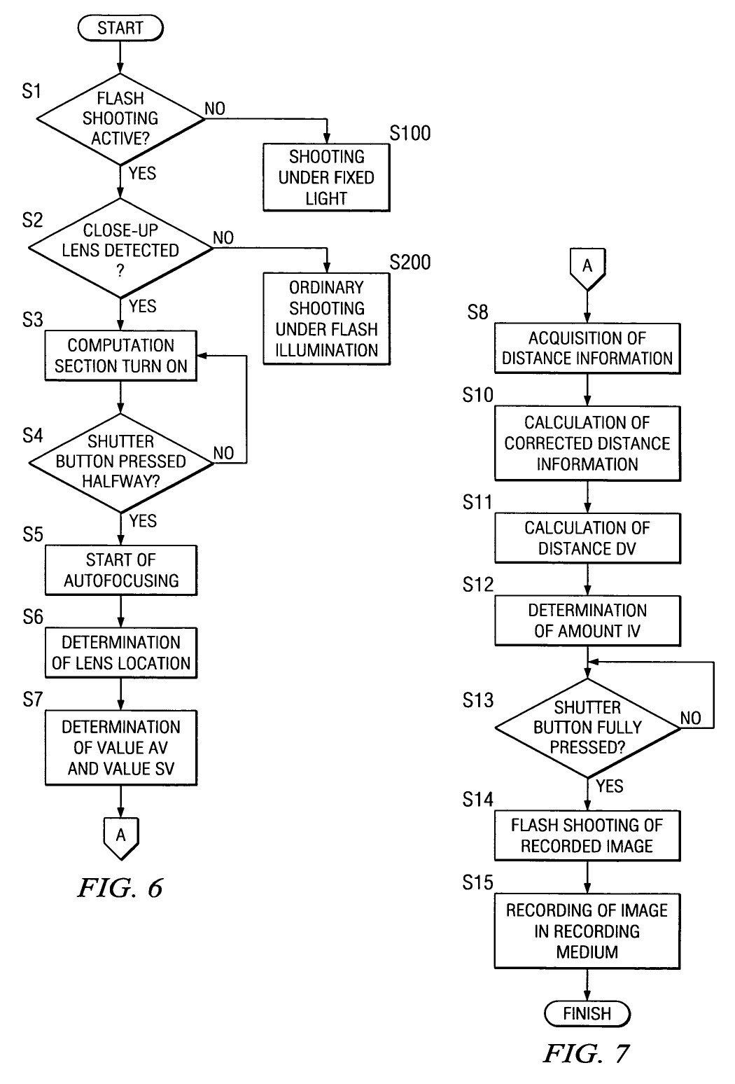

The sequence of the operation within the image capturing apparatus 1 will now be described with reference to the flow charts in FIGS. 6 and 7.

First, as the power source of the image capturing apparatus 1 is turned on, the shooting control section 20 determines whether flash shooting is active in accordance with the setting given by a user (Step S1). The sequence proceeds to Step S100 when flash shooting is not active. At Step S100, shooting is performed under fixed light without preflash firing. Shooting under fixed light is not processing relevant to the present invention, and hence, the specific content of this processing will not be described.

On the contrary, when flash shooting is set active, the sequence proceeds to Step S2 at which the shooting control section 20 determines whether the mounting detecting section 28 has detected the close-up lens 6. When the close-up lens 6 is not mounted, the sequence proceeds to Step S200. At Step S200, flashmatic control described above is not performed and ordinary shooting under flash illumination is executed. For instance, preflash is fired, the firing amount of flash or the like is determined and shooting under flash illumination is carried out by means of dimmer control. Ordinary shooting under flash illumination at Step S200 is not processing relevant to the present invention, and hence, the specific content of this processing will not be described.

In the event that the close-up lens 6 is detected at Step S2, the sequence proceeds to Step S3 at which the function of the computation section 21 for correcting distance information is turned on. The control method for flash shooting is switched to flashmatic control at this stage.

Whether a user pressed the shutter button 4 halfway is then determined (Step S4), and in response to the determination that the shutter button 4 has been pressed halfway, autofocusing starts (Step 5). At this stage, the shooting control section 20 drives the focusing lens 31 along the optical axis L at a predetermined pitch over a few stages and specifies a location at which the contrasts regarding image components within the focus area become maximum. A lens location at which the image of the subject is focused during autofocusing is then determined (Step S6). In the case of manual focusing, the focusing lens 31 moves as a user operates the focusing ring 3a and a lens location at which the focusing lens 31 has finally come to a halt is adopted.

Exposure control (AE) is also performed at this stage, thereby determining the aperture diaphragm value AV and the sensitivity SV in terms of APEX (Step S7).

Proceeding to the flow chart in FIG. 7, the shooting control section 20 acquires from the distance detecting section 29 distance information which is based on the current lens location of the focusing lens 31 (Step S8). The distance information acquired at this stage is distance information calculated only from the optical characteristic of the image taking lens 3, i.e., distance information within the range from the closest location to infinite distance.

Proceeding to Step S10, the computation section 21 functions, whereby precise distance information considering the close-up lens 6 is calculated based on information read from the mounted lens LUT 23 and the distance information fed from the distance detecting section 29. From the distance information calculated at Step S10, the subject distance DV in terms of APEX is calculated (Step S11).

Subsequently, the calculation expressed as Equation 1 is executed, the firing amount of flash IV from the light emission parts 7a is determined, and the shooting control section 20 instructs the flash control section 8 the amount IV of light emission (Step S12). At this stage, the amount IV of light emission becomes equal to or smaller than the lower limit value, the amount IV of light emission is fixed to the lower limit value and one of the aperture diaphragm value AV and the sensitivity SV or both of these is re-adjusted so as to satisfy the relationship expressed as Equation 1.

Whether the user has fully pressed the shutter button 4 is then determined. (Step S13), and in the event that the shutter button 4 has been fully pressed, flash shooting for recording of an image is carried out (Step S14). In other words, the shooting control section 20 drives such that the aperture diameter of the diaphragm plate 30 becomes adaptable to the aperture diaphragm value AV, and after setting the gain in the AGC circuit 12 to a value which is adaptable to the sensitivity SV, the shooting control section 20 feeds a shooting command to the timing generator 27 and sends a flash fire command to the flash control section 8.

In consequence, the image signal stored in the image memory 14 is recorded in the recording medium 18 after processed through image processing such as compression by the image processing circuit 15, which completes the shooting processing (Step S15). An optimal image not overexposed is recorded in the recording medium 18 in this manner.

As described above, the image capturing apparatus 1 according to the preferred embodiment is structured so that the close-up lens 6 which is the second optical system is mounted to the objective side of the image taking lens 3 which is the first optical system, and upon detecting of mounting of the close-up lens 6 to the image taking lens 3, flash fire control is switched to flashmatic control. Although dimmer control by means of preflash firing has a problem that overexposure tends to occur in a short-distance shooting, in the preferred embodiment, a situation of performing short-distance shooting is automatically and accurately detected and short-distance shooting under flash illumination is performed under flashmatic control, which in turn favorably prevents overexposure of the shot image.

Further, in the image capturing apparatus 1 according to the preferred embodiment, during flashmatic control, the distance detecting section 29 detects information regarding a distance to a subject depending upon the focusing state of the image of the subject which is obtained via the image taking lens 3. However, in the condition that the close-up lens 6 is mounted to the image taking lens 3, distance information detected by the distance detecting section 29 is not precise information. Noting this, the image capturing apparatus 1 is structured such that after detection of mounting of the close-up lens 6, the image capturing apparatus 1 corrects the distance information detected by the distance detecting section 29 based on information regarding the close-up lens 6 stored in the memory 22 and flashmatic control is executed based on thus corrected distance information. The image capturing apparatus 1 according to the preferred embodiment is capable of calculating a subject distance as a more error-free value at a high resolution during shooting over a short distance, and hence, is capable of performing highly accurate flashmatic control.

In addition, since the plurality of light emission parts 7a are arranged around the optical axis L equidistant from the optical axis L in the image capturing apparatus 1 according to the preferred embodiment, it is possible to approximately evenly irradiate a subject which is within the short-distance region. Although short-distance shooting under flash illumination in particular results in uneven irradiation upon a subject, the even arrangement of the plural light emission parts 7a around the optical axis L as in the preferred embodiment suppresses the uneven irradiation and a subject can be shot in a favorable condition.

While the foregoing has described the preferred embodiment of the present invention, the present invention is not limited to the above.

For instance, the preferred embodiment above is directed mainly to an example that upon detection of mounting of the close-up lens 6, distance information obtained by the distance detecting section 29 is corrected based on information regarding the close-up lens 6, the firing amount IV of light emission is determined as a priority based on thus corrected distance information, and when the amount IV of light emission becomes equal to or smaller than the predetermined lower limit value, the aperture diaphragm value AV or the sensitivity SV is adjusted. However, the firing amount of flash from the light emission parts 7a could be always constant, in which case it is not possible to adjust the amount of light emission. Hence, when it is not possible to adjust the firing amount of flash IV, at least one of the aperture diaphragm value AV and the sensitivity SV is adjusted while fixing the amount IV of light emission to thereby satisfy the relationship expressed as Equation 1 described above. In short, the present invention is applicable to flash shooting with at least one of the firing amount of flash IV, the aperture diaphragm value AV and the sensitivity SV adjusted.

Further, the preferred embodiment above is directed mainly to an example that flashmatic control is executed for shooting under flash illumination an image which is to be recorded in response to full pressing of the shutter button 4 by a user (i.e., shooting command). This eliminates the necessity of preflash firing, the firing amount of flash for shooting/recording can be determined efficiently in the preferred embodiment above. However, this technique described above, according to which upon detection of mounting of the close-up lens 6, distance information obtained by the distance detecting section 29 is corrected based on information regarding the close-up lens 6, at least one of the firing amount of flash IV, the aperture diaphragm value AV and the sensitivity SV is adjusted based on thus corrected distance information, is applicable not only to shooting for recording of an image but also to determination of the firing amount of preflash for an instance that dimmer control is carried out with firing of preflash. Thus, the present invention is not limited to flash shooting which is for acquisition of an image-to-be-recorded in response to a shooting command, but is applicable also to determination of the amount of light emission during firing of preflash. With the firing amount of preflash during firing of preflash determined as described above, it is possible to prevent overexposure of an image acquired during firing of preflash and obtain an optimal image even during flash shooting which utilizes dimmer control.

Further, while the preferred embodiment above is directed to an example that the flash apparatus 7 is externally mounted to the main camera body 2, the flash apparatus 7 may be built within the main camera body 2. Further, the light emission parts 7a may be attached directly to a lens mirror barrel of the close-up lens 6.

Further, while the preferred embodiment above is directed to an example that the distance detecting section 29 detects a distance to a subject depending upon the lens location of the focusing lens 31 which is included in the image taking lens 3, this is not limiting. For example, a phase difference sensor or the like of the TTL (through the lens) method may determine the focusing state of the image of the subject, to thereby detect the distance to the subject.

Further, although the foregoing has described that information regarding the close-up lens 6 is stored as the mounted lens LUT 23 in the memory 22 in the preferred embodiment above, the memory 22 may be disposed to the main camera body 2 in advance or built within the close-up lens 6. In the event that the memory 22 is to be incorporated within the close-up lens 6, the main camera body 2 and the close-up lens 6 need to get electrically connected and the shooting control section 20 needs to become accessible to the memory 22 inside the close-up lens 6 as the close-up lens 6 is mounted to the image taking lens 3.

Further, although the preferred embodiment above is directed to an example that the mounting detecting section 28 automatically judges mounting of the close-up lens 6, this is not limiting. For example, the liquid crystal display 17 or the like may display a menu screen, and a user may operate the operation section 24 and manually enter that the user has mounted the close-up lens 6 to the front end portion of the image taking lens 3. In this case, the mounting detecting section 28 detects mounting of the close-up lens 6 based on information regarding the mounted lens entered by the user.

Further, the preferred embodiment above is directed to an example that the second optical system mounted to the objective side of the image taking lens 3 which is the first optical system is the close-up lens 6. However, the present invention does not limited the optical system mounted to the objective side of the image taking lens 3 to the close-up lens 6. For instance, such an image capturing apparatus is known in which a teleconvertor lens which expands the shooting magnification, a wide converter lens which increases the angle of field (viewing angle range) or the like can be mounted to a image taking lens is known. In the event that such a teleconvertor lens or wide converter lens is attached to a image taking lens, since the optical characteristic of the image capturing apparatus becomes different from the optical characteristic which is observed on the image taking lens alone, a distance to a subject detected by the distance detecting section 29 is an inaccurate value. The technique described in relation to the preferred embodiment above of correcting information detected by the distance detecting section 29 and performing flash shooting is not limited to a structure that the second optical system is a close-up lens but is applicable also to a structure that the second optical system is a teleconvertor lens, a wide converter lens, etc.

Although the present invention has been fully described by way of examples with reference to the accompanying drawings, it is to be noted that various changes and modifications will be apparent to those skilled in the art. Therefore, unless otherwise such changes and modifications depart from the scope of the present invention, they should be construed as being included therein.

1. An image capturing apparatus comprising:
a light emission section which emits flash;
a first optical system which directs a light image of a subject to an imaging element;
an aperture diaphragm member which adjusts a light amount directed by said first optical system;
a distance detecting section which detects a distance information to the subject based upon a focusing state of the light image of the subject obtained through the first optical system;
a second optical system mounted to an objective side of the first optical system;
a detecting section which detects that the second optical system is mounted to the first optical system;
a storage section which stores an information regarding the second optical system; and
a controller, when the detecting section detects that the second optical system is mounted to the first optical system, said controller correcting said distance information detected by said distance detecting section based upon the information regarding the second optical system, and performing flash shooting while adjusting at least one of the amount of light emitted by the light emission section, the aperture diaphragm value of the aperture diaphragm member and a gain applied upon an image signal obtained by the imaging element based on corrected distance information.

2. An image capturing apparatus as claimed in claim 1, wherein the second optical system is a close-up lens.

3. An image capturing apparatus as claimed in claim 1, wherein the second optical system is a teleconverter lens for expanding a shooting magnification with respect to the first optical system.

4. An image capturing apparatus as claimed in claim 1, wherein the second optical system is a wide converter lens for increasing an angle of field.

5. An image capturing apparatus as claimed in claim 2, wherein the storage section is provided inside of said close-up lens.

6. An image capturing apparatus as claimed in claim 1, wherein the information stored in the storage section includes a focal length of the second optical system.

7. An image capturing apparatus as claimed in claim 1, wherein the controller performs the flash shooting in response to an instruction inputted by an operator, and records the image signal obtained by the flash shooting in a predetermined recording medium.

8. An image capturing apparatus as claimed in claim 1, wherein the controller performs the flash shooting for preflash before shooting of a recorded image.

9. An image capturing apparatus as claimed in claim 1, wherein the light emission section includes a plurality of light emission parts arranged symmetrical with respect to an optical axis of the first optical system, and are equidistant from the optical axis.

10. An image capturing apparatus, which is provided with a light emission section for emitting flash and to which a close-up lens is mounted, said image capturing apparatus comprising:
a detecting section which detects that the close-up lens is mounted to the image capturing apparatus; and
a controller which switches a flash shooting control of said light emission section from a dimmer control to a flashmatic control when the detecting section detects that the close-up lens is mounted to the image capturing apparatus.

11. An image capturing apparatus as claimed in claim 10, wherein said controller performs the flash shooting in response to an instruction inputted by an operator, and records the image signal obtained by the flash shooting in a predetermined recording medium.

12. An image capturing apparatus as claimed in claim 10, wherein the controller performs the flash shooting for preflash before shooting of a recorded image.

13. An image capturing apparatus as claimed in claim 10, wherein the light emission section includes a plurality of light emission parts arranged symmetrical with respect to an optical axis of the first optical system, and are equidistant from the optical axis.

14. An image capturing apparatus, which is provided with a light emission section for emitting flash and to which a close-up lens is mounted, said image capturing apparatus comprising:
a detecting section which detects whether a shooting range of the image capturing apparatus is translated into a short-distance region; and
a controller which performs a flash shooting under a dimmer control when the detecting section does not determine that the shooting range is translated into the short-distance region, and which performs the flash shooting under a flashmatic control when the detecting section determines that the shooting range is translated into the short-distance region.

15. An image capturing apparatus as claimed in claim 14, further comprising:
a first optical system which directs a light image of a subject to an imaging element; and
a second optical system mounted to an objective side of the first optical system, wherein said distance detecting section detects that the shooting range is translated into the short-distance region by detecting that the second optical system is mounted to the objective side of the first optical system.

16. An image capturing apparatus as claimed in claim 15, wherein said first optical system is an image taking lens, and said second optical system is a close-up lens.

17. An image capturing apparatus as claimed in claim 14, further comprising:
a first optical system which directs a light image of a subject to an imaging element; and
a second optical system mounted to an objective side of the first optical system, wherein said distance detecting section detects that the shooting range is translated into the short-distance region by detecting that an operator inputs an instruction of mounting of the second optical system to the objective side of the first optical system.
